(19) United States
(12) Patent Application Publication
(10) Pub. No.: US 2011/0241857 A1
(43) Pub. Date: Oct. 6, 2011

(54) DRIVER ASSISTANCE METHOD FOR MOVING A MOTOR VEHICLE AND DRIVER ASSISTANCE DEVICE

(76) Inventors: Sabine Brandenburger, Mannheim (DE); Roland Schmid, Stuttgart (DE); Benno Albrecht, Kirchheim-Teck (DE); Benoit Mangin, Stuttgart (DE)

(21) Appl. No.: 12/991,633

(22) PCT Filed: Nov. 17, 2008
(86) PCT No.: PCT/EP08/65688

§ 371 Date: Jun. 23, 2011

(30) Foreign Application Priority Data
May 8, 2008 (DE) 102008001648.9

(51) Int. Cl. B60Q 1/00

(52) U.S. Cl. 340/435

(57) ABSTRACT

A driver assistance method for moving a motor vehicle, in particular for avoiding collisions, using at least one first sensor system which provides first items of obstacle information within a first detection zone for notifying the motor vehicle driver of an obstacle while an obstacle is located in the first detection zone, and using at least one second sensor system, which provides second items of obstacle information within a second detection zone which is located at an angle greater than 0° in relation to the first detection zone even if the obstacle is no longer located in the second detection zone. It is provided that the first and second items of obstacle information are combined in such a way that detection errors of the sensor systems are corrected and an updated item of obstacle information is provided. Also described is a driver assistance device, in particular for carrying out the driver assistance method according to the aforementioned embodiments.

### FIELD OF THE INVENTION

The present invention relates to a driver assistance method for moving a motor vehicle, in particular for avoiding collisions, using at least one first sensor system which provides a first item of obstacle information within a first detection zone for notifying the motor vehicle driver of an obstacle while an obstacle is located in the first detection zone, and using at least one second sensor system which provides a second item of obstacle information within a second detection zone which is located at an angle greater than 0° in relation to the first detection zone even if the obstacle is no longer located in the second detection zone. The present invention also relates to a driver assistance device, in particular for carrying out the driver assistance method.

### BACKGROUND INFORMATION

Driver assistance methods which continuously measure distances to obstacles in front of and behind the vehicle, for example using ultrasonic or radar sensors, are known. These methods also include a display of the measured distances. A distinction is made between acoustic and optical displays. In the first case, the measured distances are signaled, for example using warning tones whose intervals are varied along with the measured distances to the obstacle. In the second case, the measured distances are displayed, for example using light bars or with the aid of a two-dimensional birds-eye representation, which also provides a schematic representation of the vehicle surroundings. A combination of acoustic and optical feedback is also common. In these systems obstacles in the vehicle surroundings are displayed only while they are being detected by the sensors. Another design of the driver assistance methods provides a method which supports parking in longitudinal parking spaces. In contrast to the methods described above, this method displays the distances to obstacles which form, for example, the limits of a parking space even if these obstacles are no longer being detected by the motor vehicle sensors. A common procedure in this case is to record and store data from the sensors while driving past, for example, a parking space. The information on obstacles is thus available during a subsequent parking maneuver, even though the sensor may no longer be detecting all existing obstacles. A method of this type is discussed in German patent document DE 4333112 A1 for leaving a parking space.

### SUMMARY OF THE INVENTION

On this basis, an object of the exemplary embodiments and/or exemplary methods of the present invention is to provide consistent information about obstacles located in the motor vehicle surroundings independently of the system used to detect the obstacle.

To achieve this object a driver assistance method is proposed which has the features described herein. It is characterized by the fact that the first and second items of obstacle information are combined in such a way that detection errors of the sensor systems are corrected and an item of updated obstacle information is provided. In the simplest design, the sensor systems may each have a single sensor. To ensure reliable detection of obstacles in the area around the motor vehicle, multiple sensors may be provided for the sensor systems. For example, it may be provided that one sensor system has sensors at the front and rear of the motor vehicle and a further sensor system has sensors on the sides of the vehicle. The sensors on the sides of the vehicle may be situated in such a way that early detection of obstacles is possible when the motor vehicle moves in the direction of travel. For this purpose, the sensors may be situated near the front of the vehicle. Furthermore, the sensors of the sensor systems may have different ranges. These ranges may be selected according to the intended application. For example, the sensors at the front of the vehicle and at the rear of the vehicle may have a shorter range than the sensors directed toward the side of the vehicle.

The detection zones of the sensor systems are derived from the position and orientation of these sensor systems. According to the above discussion, a distinction is made between the first detection zone and the second detection zone. According to the exemplary embodiments and/or exemplary methods of the present invention, the detection zones are situated in relation to each other at an angle which is larger than 0°. An overlapping of the detection zones may also be provided to enable a position of obstacles to be more precisely determined. According to the exemplary embodiments and/or exemplary methods of the present invention, the first sensor system provides obstacle information while an obstacle or multiple obstacles is/are located in the first detection zone.

The second sensor system, in contrast, provides obstacle information even if the obstacle is no longer located in the detection zone of the second sensor system. The instantaneous obstacle information of the first sensor system and the continuous obstacle information of the second sensor system are then combined in such a way that detection errors of the sensor systems are corrected. A plausibility check of the obstacle information of the sensor systems may be carried out. In particular, it is thus possible to determine which items of obstacle information are valid or have a higher degree of accuracy. After the items of obstacle information of the first and second sensor systems are combined, the driver assistance method provides updated obstacle information.

By combining the two sensor systems, combining the obstacle information and carrying out the plausibility check or correcting detection errors of the sensor systems, obstacle information is obtained which has a higher degree of accuracy than the obstacle information of the two separately operating sensor systems. The plausibility check may, for example, use a measuring point in time of the first and second sensor systems and employ the more recent obstacle information in each case or always supply the smallest measured distance for safety reasons. A collision of the motor vehicle with an obstacle may be efficiently avoided in this manner. An application of the driver assistance method described above may be useful in many situations, depending on the operating state of the motor vehicle.

In contrast to the methods described in the related art, in which each sensor system is assigned a specific task, the sensor systems are combined according to the present invention, which results in a much larger range of applications. Conceivable applications are, for example, a parking aid (similar to the two individual methods, but having a much higher accuracy), an apparatus which warns the motor vehicle driver when opening a motor vehicle door would cause the door to collide with an obstacle, and/or a system which warns against a collision of a side of the motor vehicle on the inside of the curve with an obstacle during a turning maneuver of the vehicle, which may occur, for example, when driving into narrow parking garages or when parking in a transverse parking space.

According to a refinement of the exemplary embodiments and/or exemplary methods of the present invention, the driver is visually and/or acoustically notified of obstacles within the detection zones. In this case, technologies are possible such as warning tones whose pitch and/or repetition frequency is/are varied as a function of a distance to a detected obstacle or visual feedback for the driver using light bars whose color, shape and/or number are also varied as a function of the distance to the obstacle.

According to a refinement of the exemplary embodiments and/or exemplary methods of the present invention, the updated obstacle information is converted to a graphical, in particular two-dimensional, representation. A two-dimensional representation of the motor vehicle and its surroundings viewed from above, i.e., from a bird's eye perspective, may be advantageously used. For example, a map of the area around the motor vehicle may be shown or, in a simpler design, the distances from the obstacles to the motor vehicle may be shown using suitable optical means, such as an indication of the distance as a numerical value, using color coding and/or using a dimension of a symbol.

According to a refinement of the exemplary embodiments and/or exemplary methods of the present invention, the driver is warned when dropping below a minimum distance between the motor vehicle and the obstacle. In this embodiment variant, the method is intended not only for the purpose of notifying the driver, but also to issue a clear warning in critical situations. This is particularly important not only while maneuvering into or out of a parking space, during which maneuver the driver is already focusing attention on the motor vehicle's immediate vicinity, but it is also important while driving, for example, along narrow paths. This may be relevant, for example, in a parking garage. In this case, the driver assistance method detects obstacles around the vehicle with the aid of the associated sensor systems, determines the positions of these obstacles relative to the outside of the motor vehicle and thus issues a warning to the driver of the motor vehicle when the distance to an obstacle becomes smaller than a set minimum distance.

According to a refinement of the exemplary embodiments and/or exemplary methods of the present invention, only obstacle information which is relevant for the driver in an instantaneous operating state of the motor vehicle is used for visual and/or acoustic notification of the driver. To avoid unnecessarily distracting the motor vehicle driver, only obstacle information which is necessary for managing the instantaneous driving situation is forwarded to the driver. For example, a distinction is made between forward and backward operation of the motor vehicle, and the speed of the motor vehicle may also be incorporated into an assessment of this type.

According to a refinement of the exemplary embodiments and/or exemplary methods of the present invention, sensors of the first sensor system are used by the second sensor system and/or sensors of the second sensor system are used by the first sensor system. For example, it may be provided that each sensor of the motor vehicle may be activated by each of the sensor systems. This is practical, in particular if the detection zones of the sensor systems to be provided overlap, and if multiples sensors would thus have to be positioned at the same location. However, the sensors may also be used only to supplement the obstacle information and/or to check the plausibility thereof, i.e., to check the information for correctness.

According to a refinement of the exemplary embodiments and/or exemplary methods of the present invention, the obstacle information is stored in a memory.

According to a refinement of the exemplary embodiments and/or exemplary methods of the present invention, the stored obstacle information is supplemented and/or corrected by the updated obstacle information, in particular taking into account the instantaneous operating state of the motor vehicle—which may be the position, speed and/or direction of the motor vehicle. For example, if an obstacle previously detected by one of the sensor systems is again detected by one of the sensor systems, it is necessary to update the obstacle information stored in the memory. This applies, in particular, if the information measured at a later point in time differs from the information stored in the memory. In this case, the information stored in the memory must be updated to the newer status, possibly after running a plausibility check. A movement of the motor vehicle is frequently the cause of a discrepancy between measured and stored obstacle information.

Therefore, the instantaneous operating state of the motor vehicle must be taken into account each time the information is supplemented and/or corrected. The position, speed and/or direction of travel of the motor vehicle may be incorporated into the updated obstacle information. The instantaneous operating state is also a criterion for determining when an obstacle may be deleted from the memory, when it is located at a distance from the vehicle and is thus no longer relevant for the motor vehicle driver. Furthermore, a display strategy which takes into account a change in the obstacle information may be necessary. Two basic options for a display strategy of this type are a sudden, abrupt adjustment to or a smooth, gradual change in the visual driver information.

The exemplary embodiments and/or exemplary methods of the present invention furthermore includes a driver assistance device, in particular for carrying out the driver assistance method according to the above discussion, having at least one first item of obstacle information of a first sensor system which senses a first detection zone and having at least one second item of obstacle information of a second sensor system which senses a second detection zone, the first and second sensor systems being situated in such a way that their detection zones are located at an angle greater than 0° in relation to each other, and both sensor systems being connected to at least one evaluation circuit which has at least one memory for storing the first and/or second item(s) of obstacle information even if an obstacle is no longer located in the detection zones, and having at least one display device and/or device for emitting acoustic signals. The driver assistance device is characterized by the fact that the evaluation circuit is designed as an obstacle information processing unit which corrects detection errors for the purpose of combining and providing an updated item of obstacle information.

According to a refinement of the exemplary embodiments and/or exemplary methods of the present invention, the first and/or second sensor system(s) include(s) ultrasonic and/or radar sensors.

According to a refinement of the exemplary embodiments and/or exemplary methods of the present invention, sensors for determining the position and/or speed and/or direction of the motor vehicle are provided on the motor vehicle. For example, a sensor which is used to detect wheel rotation is used for this purpose. A distance covered and thus a change in position as well as a speed of the vehicle may then be ascertained from the wheel rotation, taking into account the wheel circumference.

The exemplary embodiments and/or exemplary methods of the present invention is explained in greater detailed below in an exemplary embodiment on the basis of the corresponding drawings.

### BRIEF DESCRIPTION OF THE DRAWINGS

FIG. 1 schematically shows a representation of a motor vehicle having a first and a second sensor system as well as the sensor systems and detection zones thereof.

FIG. 2a shows the motor vehicle while parking in a longitudinal parking space, using the driver assistance method described above.

FIG. 2b shows the motor vehicle while parking in a longitudinal parking space as well as a graphical representation of obstacle information after driving past the parking space.

FIG. 2c shows the motor vehicle while parking in the longitudinal parking space as well as a graphical representation of an updated item of obstacle information.

FIG. 3a shows the motor vehicle while parking in a transverse parking space as well as the detection zones of the sensor systems.

FIG. 3b shows the graphical representation of the obstacle information obtained during the parking maneuver of the motor vehicle from FIG. 3a.

FIG. 4a shows the motor vehicle having a driver assistance method according to the related art as well as a sensor field of view resulting from the detection zones of the sensor systems.

FIG. 4b shows the motor vehicle having a driver assistance method according to the above discussion as well as the resulting sensor field of view.

### DETAILED DESCRIPTION

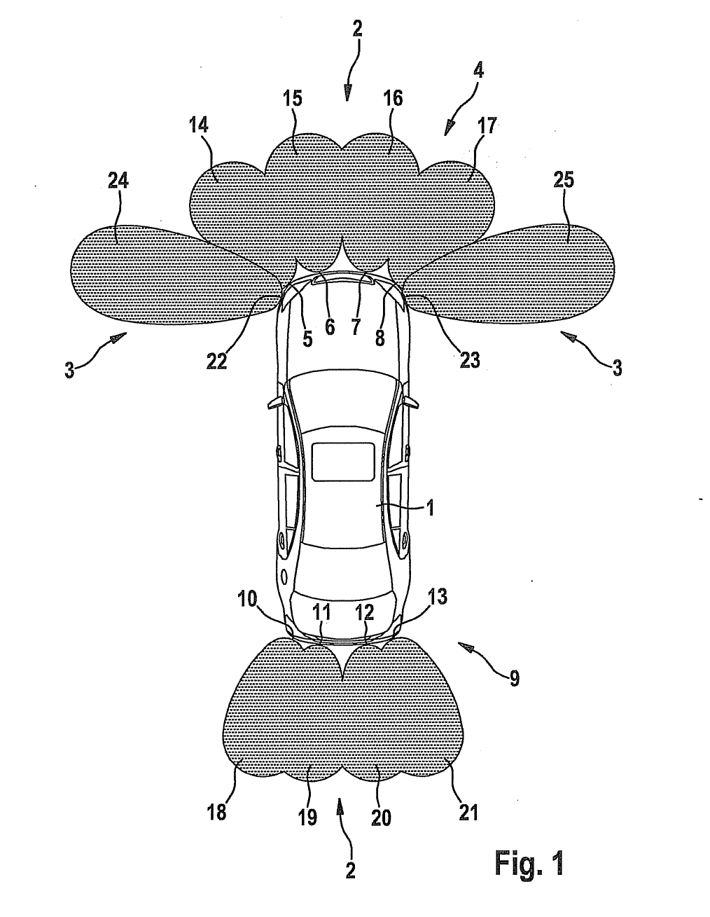

FIG. 1 shows a motor vehicle 1, in which a driver assistance method according to the present invention is used, which has a first sensor system 2 and a second sensor system 3. First sensor system 2 has front sensors 4 (sensors 5 through 8) as well as rear sensors 9 (sensors 10 through 13). Front sensors 4, i.e., sensors 5, 6, 7 and 8, are assigned to detection zones 14 through 17, and rear sensors 9, i.e., sensors 10, 11, 12, 13, are assigned to detection zones 18 through 21. Second sensor system 3 has a left sensor 22 and a right sensor 23, which are assigned to detection zones 24 and 25. Second sensor system 3 is designed in such a way that detection zones 24, 25 extend along the left or right side of motor vehicle 1 and have a greater range than front sensors 4 or rear sensors 9. Front sensors 4 are designed in such a way that detection zones 14, 15, 16 and 17 overlap. The same applies to detection zones 18, 19, 20, 21 of rear sensors 9. Sensor 5 of first sensor system 2 and sensor 22 of second sensor system 3 also have overlapping detection zones 14 and 24. The same applies to sensors 8 and 23, which have corresponding detection zones 17 and 25.

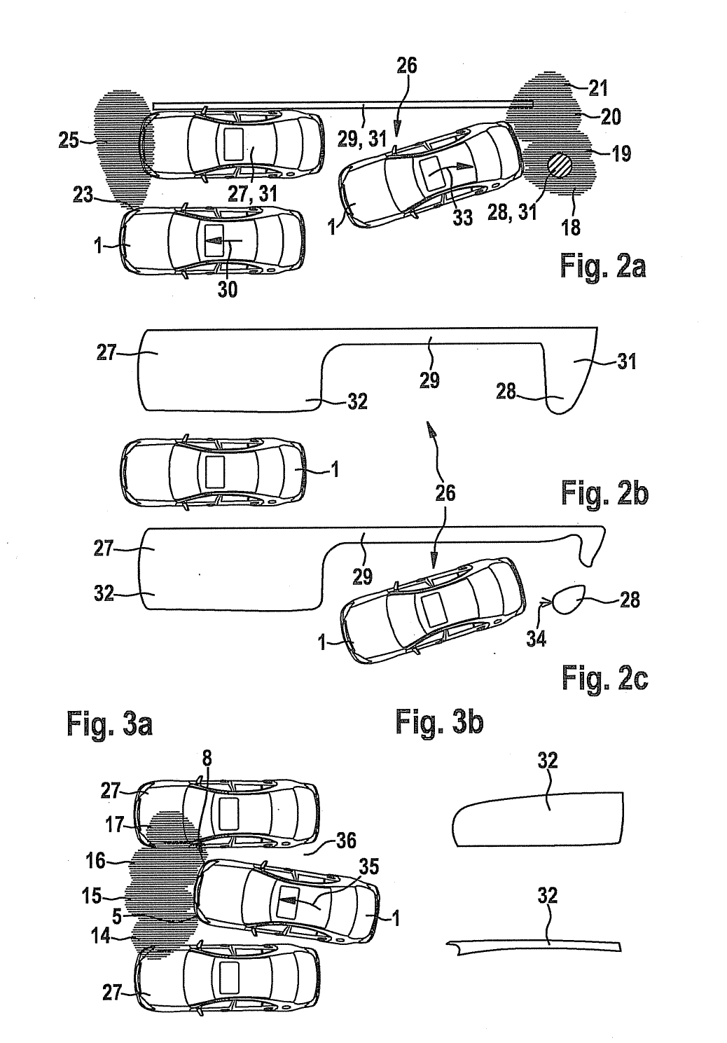

The function sequence of the driver assistance method is discussed below: FIG. 2a shows motor vehicle 1 during a parking maneuver into a longitudinal parking space 26. This parking space is limited by a stopped motor vehicle 27, a post 28 and a curb 29. During the parking maneuver, motor vehicle 1 first moves in the direction of arrow 30 to post 28, curb 29 and at least partially to stopped vehicle 27. The latter lie in detection zone 25 of sensor 23 belonging to second sensor system 3 and are detected as obstacles 31. Information about these obstacles 31 is then converted to a graphical representation. This graphical representation is illustrated in FIG. 2b. After motor vehicle 1 moves past obstacles 31, as described above, and after obstacles 31 are detected by sensor 23, an item of obstacle information is produced which is displayed to a driver of motor vehicle 1 in the form of graphical representation 32 of the obstacle information. The projection direction of sensor 23 is clearly apparent from representation 32 of the obstacle information. Although a useable representation 32 of the situation is provided on the whole, some details are not yet displayed or may not yet have been detected by first sensor system 2 or second sensor system 3. Longitudinal parking space 26 is already recognizable, limited in the longitudinal direction by stopped vehicle 27 and post 28, and limited in the lateral direction by curb 29. However, post 28 is detected as a massive obstacle 31 in the direction of detection zone 25, starting from motor vehicle 1. The distance between motor vehicle 1 and curb 29 has also not yet been correctly evaluated.

Motor vehicle 1 subsequently backs up in the direction of arrow 33, as illustrated in FIG. 2a, and turns into longitudinal parking space 26. During the parking maneuver, post 28 and curb 29 enter the detection zone of rear sensors 9, in particular post 28 enters detection zones 18 and 19 and curb 29 enters detection zone 21. The resulting updated obstacle information is used to update the obstacle information stored in a memory. Resulting representation 32 of the obstacle information is illustrated in FIG. 2c. It is clearly apparent that representation 32 illustrated in FIG. 2b is adapted to the obstacle information of rear sensors 9.

In particular, this results in a substantial correction of the obstacle information for post 28, and the contour of post 28 is now much more accurately displayed. The distance from curb 29 is also substantially corrected within detection zone 21. By combining the obstacle information of first sensor system 2 and second sensor system 3, the obstacle information is ultimately made more specific, and representation 32 of this information is substantially improved. Such changes in the obstacle information may be specifically brought to the attention of the driver of motor vehicle 1, for example using a special signal 34 in representation 32.

FIG. 3a shows a motor vehicle 1 which is parking in a transverse parking space 36 in the direction of arrow 35. The transverse parking space is limited on the side by two stopped vehicles 27. In particular, sensors 5 and 8, along with their detection zones 14 and 17, provide an indication of the distance between motor vehicle 1 and stopped vehicles 27. Likewise, obstacle information is derived from second sensor system 3, which includes sensors 22, 23, and their assigned detection zones 24, 25 (not illustrated). FIG. 3b shows graphical representation 32 resulting from the obstacle information. In this example, the driver of motor vehicle 1 may be warned, for example, explicitly to refrain from opening a door of motor vehicle 1, which is not illustrated in further detail.

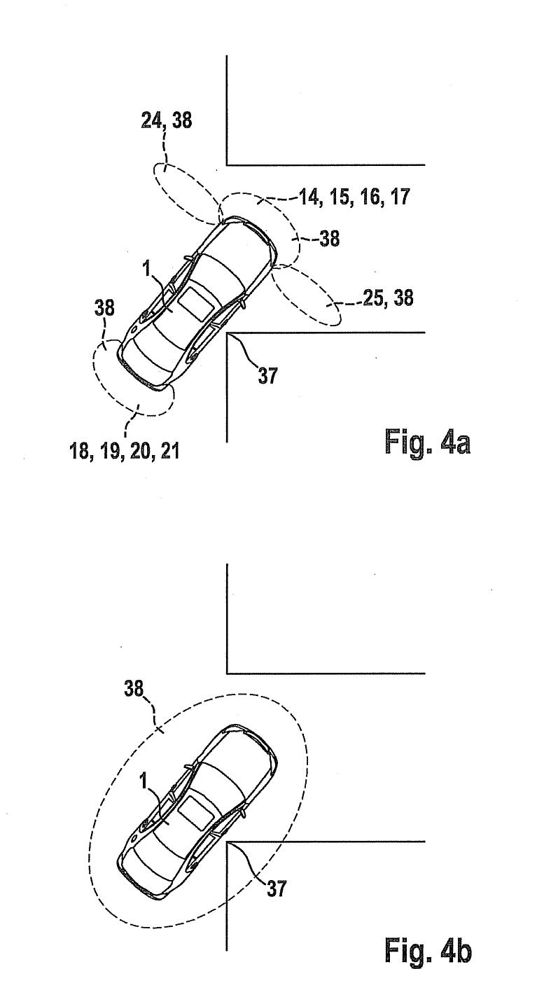

FIGS. 4a and 4b show a further application example of the driver assistance method. FIG. 4a shows a motor vehicle 1 which has a driver assistance method known from the related art. The totality of illustrated detection zones 14 through 21 and 24 and 25, and the resulting protection zone around motor vehicle 1, in which sensor systems 2, 3 continuously monitor obstacles and thus may warn the driver of a possible collision, are designated sensor field of view 38 of sensor systems 2, 3. In the known method illustrated in FIG. 4a, the obstacle information from detection zones 14, 15, 16, 17, 18, 19, 20, 21 of first sensor system 2 and the obstacle information from detection zones 24 and 25 of second sensor system 3 are neither detected continuously nor combined. This information is thus also not used to correct detection errors of sensor systems 2, 3, or to provide an updated item of obstacle information. As a result, while a house wall edge 37 may briefly enter detection zone 25, for example in narrow paths or during sharp turns, it is not used to warn the driver of motor vehicle 1 of a possible collision between house wall edge 37 and motor vehicle 1.

FIG. 4b shows sensor field of view 38 of motor vehicle 1 when using the driver assistance method according to the present invention. It is clear that housing wall edge 37 lies within sensor field of view 38, due to the continuous monitoring of obstacle information from detection zones 14 through 21, and the driver of motor vehicle 1 may be warned of a possible collision.

1-11. (canceled)

12. A driver assistance method for moving a motor vehicle, for avoiding a collision, the method comprising:
notifying, using at least one first sensor system, which provides a first item of obstacle information within a first detection zone, a motor vehicle driver of an obstacle while the obstacle is located in the first detection zone;
using at least one second sensor system, which provides a second item of obstacle information within a second detection zone which is located at an angle greater than 0° in relation to the first detection zone even if the obstacle is no longer located in the second detection zone;
combining the first item of obstacle information and the second item of obstacle information so that detection errors of the sensor systems are corrected; and
providing an updated item of the obstacle information.

13. The driver assistance method of claim 12, wherein the driver is notified at least one of visually and acoustically of obstacles in the detection zones.

14. The driver assistance method of claim 12, wherein the updated obstacle information is converted to a graphical representation, which is a two-dimensional representation.

15. The driver assistance method of claim 12, wherein the driver is warned upon dropping below a minimum distance between the motor vehicle and the obstacle.

16. The driver assistance method of claim 12, wherein only obstacle information which is relevant for the driver in an instantaneous operating state of the motor vehicle is used for at least one of visually and acoustically notifying the driver.

17. The driver assistance method of claim 12, wherein at least one of the following is satisfied: (i) sensors of the first sensor system are used by the second sensor system; and (ii) sensors of the second sensor system are used by the first sensor system.

18. The driver assistance method of claim 12, wherein the obstacle information is stored in a memory.

19. The driver assistance method of claim 18, wherein the stored obstacle information is at least one of supplemented and corrected by the updated obstacle information, taking into account the instantaneous operating state of the motor vehicle, which includes at least one of a position, a speed and a direction of the motor vehicle.

20. A driver assistance device for providing driver assistance, comprising:
a first sensor system, which senses a first detection zone, and provides at least one first item of obstacle information;
a second sensor system, which senses a second detection zone, and provides at least one second item of obstacle information, wherein the first sensor system and the second sensor system are situated so that the first detection zone and the second detection zone are located at an angle greater than 0° in relation to each other;
at least one evaluation arrangement having has at least one memory for storing at least one of the first item of obstacle information and the second item of obstacle information, even if the obstacle is no longer located in the detection zones, wherein the first sensor system and the second sensor system are connected to the at least one evaluation arrangement; and
at least one of a display device and a device for emitting acoustic signals, wherein the evaluation arrangement is configured as an obstacle information processing unit which corrects detection errors for combining and providing an updated item of obstacle information.

21. The driver assistance device of claim 20, wherein the at least one of the first sensor system and the second sensor system include at least one of ultrasonic sensors and radar sensors.

22. The driver assistance device of claim 20, wherein sensors for determining at least one of the position, the speed, and the direction of the motor vehicle are provided on the motor vehicle.
